(19) United States
(12) Patent Application Publication
(10) Pub. No.: US 2012/0130865 A1
(43) Pub. Date: May 24, 2012

(54) Look-alike Tryout of Mail Order Product Before Purchase

(76) Inventor: Yonah Rendler, New York, NY (US)

(21) Appl. No.: 13/045,786

(22) Filed: Mar. 11, 2011

Related U.S. Application Data
(60) Provisional application No. 61/415,998, filed on Nov. 22, 2010.

(51) Int. Cl. G06Q 30/00; G06Q 90/00

(52) U.S. Cl. 705/27.2; 705/500

(57) ABSTRACT

The disclosed technology comprises a method of providing a functional version of a product to a potential buyer via postal services. The potential buyer may try out the product for a limited amount of time, and then return same to the seller or pay for the look-alike product/purchase the actual product. This method may be used with jewelry, clothing, electronics, and other items. For example, in an embodiment of the disclosed technology, a buyer may desire to try 1, 2, 3 or more diamond rings with gold bands. A cubic zirconia ring with a silver or copper alloy band may be sent to the potential buyer via mail or a courier to try out for a limited time period, during which he/she can decide whether to purchase the real product. In this manner, risk of loss of goods to the seller is lessened, and the ability to touch and feel a product which functions like the original is granted to the potential buyer before making a purchase.

### BACKGROUND OF THE DISCLOSED TECHNOLOGY

Online and mail order shopping is usually limited in that potential buyers cannot try a product before they purchase it in the same manner as can be accomplished when shopping at a physical store. When one goes to a shopping or jewelry website, for example, one must rely on pictures. While various methods of viewing an item from different angles, zooms, and colors have been employed, these two-dimensional displays are no substitute for holding the product and trying it out. Only then, can the product be seen in the proper context.

While many mail order and online retailers offer generous return policies, this is costly. For example, an electronic device, such as a router, phone, or the like, once opened, becomes a “refurbished” product which sells for less. A dress or other article of clothing, once shipped, tried on, and shipped back, must be cleaned and pressed anew. Other products are simply too expensive to entrust to the mail. A costly diamond necklace, for example, is hardly the type of purchase typically bought via website or catalog, with consumers by-and-large preferring face to face purchases that allow for viewing the product and trying it on, as opposed to placing hundreds or thousands of dollar charges on a credit card, only to return a piece of jewelry by mail, where shipping insurance is essential and the customer's funds are held in abeyance until a refund can be issued.

There exists a need to bridge the gap between in-person shopping and remote shopping. In the above-described cases and others, remote shopping is not as effective as going to a store to view an actual product. While many products are now bought online because their overall cost and quality are known, those which vary in cost and quality, or are more artistic in nature, languish behind in the world of electronic and mail order commerce.

### SUMMARY OF EMBODIMENTS OF THE DISCLOSED TECHNOLOGY

An object of the disclosed technology is to allow potential buyers to receive a version of a product for purchase that has at least some artistic and some functional characteristics of the actual product.

In an embodiment of the disclosed technology, jewelry is delivered by mail. Before the actual delivery, an image of the jewelry is shown to the customer, such as via a website/online presence or a printed catalog. A functional look-alike version of the jewelry item is sent to the customer, one which is of substantially less value than the actual jewelry item. “Substantially” is defined as at least 50% less value, but may also be at least 80% less value. An offer for sale of the jewelry item is also presented to the customer, and a response (as well as return of the functional look-alike in embodiments) is expected. If the response is positive, the jewelry item of full value (the original one shown to the customer) is sent.

In the above embodiment of the disclosed technology, the functional look-alike version may be a version of the jewelry item wherein metals in the jewelry are replaced with less expensive metals (such as gold being replaced with copper, silver with an aluminum alloy) and stones are replaced with either plastic or glass replicas, such as cubic zirconia. The functional look-alike is likely to have the same shape and color of the full-priced jewelry item.

Billing information (such as payment information) may be received by the vendor from the customer before sending the functional look-alike item, and the customer may be notified that such information will be used to charge the customer. Such a charge may be made for the service of sending out a look-alike, for the cost of the look-alike if it is not returned in a timely manner (such as within 10 or 30 days), or for the price of the actual jewelry item, if the customer decides to buy the item. A combination of these charges may be applied as well. Additionally, funds may be reserved in the amount of the purchase price of the functional look-alike before shipping the functional look-alike to the customer. In this manner, the funds are known to be available, but are only charged if the functional look-alike fails to be returned within the specified time.

This method may be utilized simultaneously for showing a plurality of pieces of jewelry to the customer.

In another method of the disclosed technology, an item is exhibited for sale in a catalog (a print catalog or online/e-commerce catalog, or any other listing of products offered). A shipping address is received, as well as a request for a version of the item, the request and address received from a customer (which is any person providing the shipping address and request for a version of the item). A different version of the item exhibited in the catalog is then shipped to the customer. This different version has one or more of aesthetic, shape, and functional characteristics of the exhibited item. It is then received back from the customer, together with an indication from the customer regarding a desire to purchase the item. If the customer desires to purchase the item (the original “full” version of the item), the originally exhibited item is sent to the customer.

A plurality of items of lesser value than those exhibited are shipped together in an embodiment of the disclosed technology, and are independently purchasable by the customer. A fee may be charged to the customer for shipping multiple versions of the item different from the exhibited item.

The aesthetic qualities may include color, the color of the shipped item being the same, or in the same color family, as the originally exhibited item. Being within the same color family is defined as two colors which are both closest to the same secondary or tertiary color as each other, or both in a shade of grey.

Functional characteristics, in an embodiment of the disclosed technology, include the possibility of wearing an item in the same manner as the originally exhibited item.

The version of the item shipped may have a value 50% or 80% less than the original item exhibited. Such an item may be a piece of jewelry.

The shape of the shipped version of the item may be identical to that of the originally exhibited item. In addition, the aesthetic and functional characteristics of the shipped version of the item may be identical (to a casual observer in passing, without special equipment) to the originally exhibited item.

### BRIEF DESCRIPTION OF THE FIGURES

FIG. 1 is a high level flow chart showing embodiments of the disclosed technology.

### DETAILED DESCRIPTION OF EMBODIMENTS OF THE DISCLOSED TECHNOLOGY

The disclosed technology comprises a method of providing a functional version of a product to a potential buyer via postal services. The potential buyer may try out the product for a limited amount of time, and then return same to the seller or pay for the look-alike product/purchase the actual product. This method may be used with jewelry, clothing, electronics, and other items. For example, in an embodiment of the disclosed technology, a buyer may desire to try 1, 2, 3 or more diamond rings with gold bands. A cubic zirconia ring with a silver or copper alloy band may be sent to the potential buyer via mail or a courier to try out for a limited time period, during which he/she can decide whether to purchase the real product. In this manner, risk of loss of goods to the seller is lessened, and the ability to touch and feel a product which functions like the original is granted to the potential buyer before making a purchase.

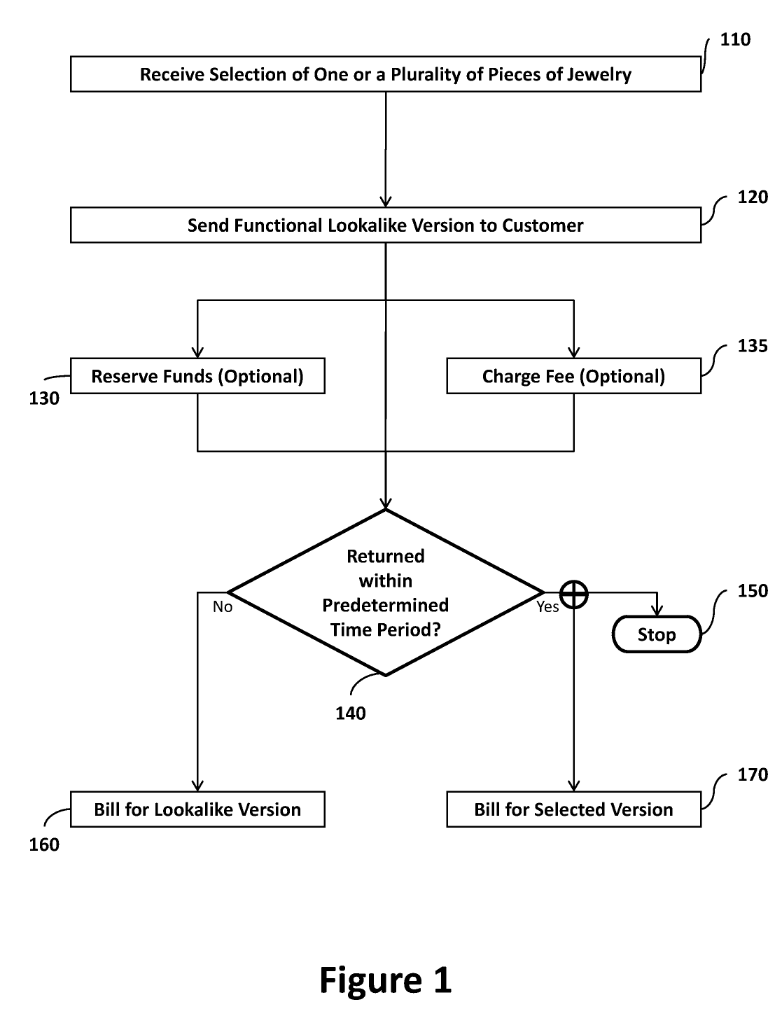

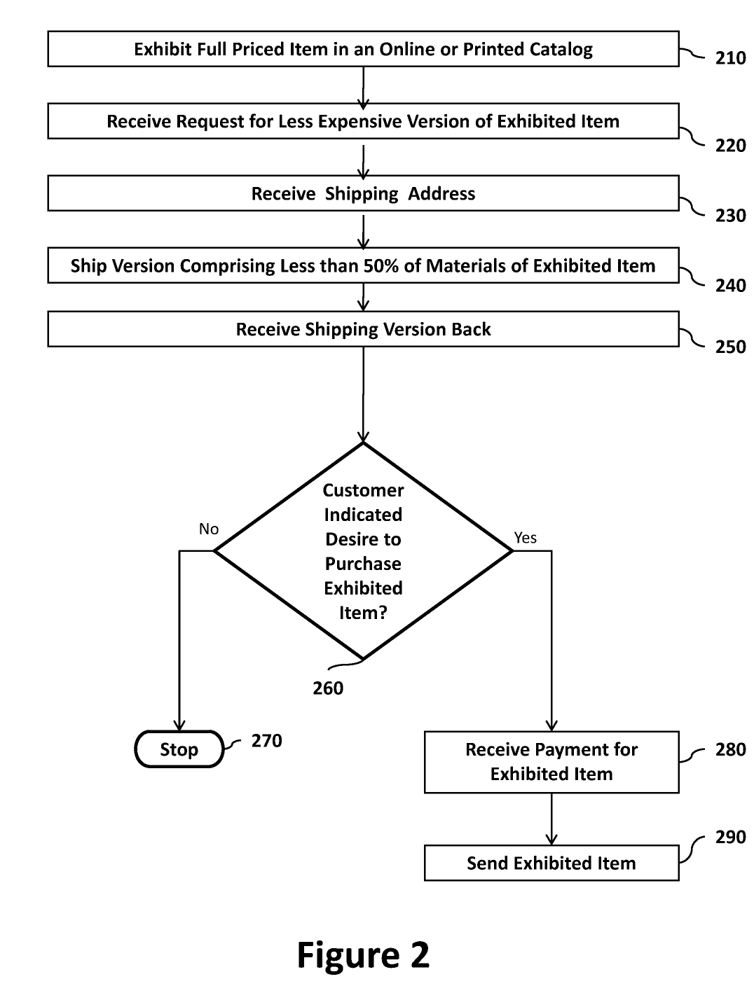

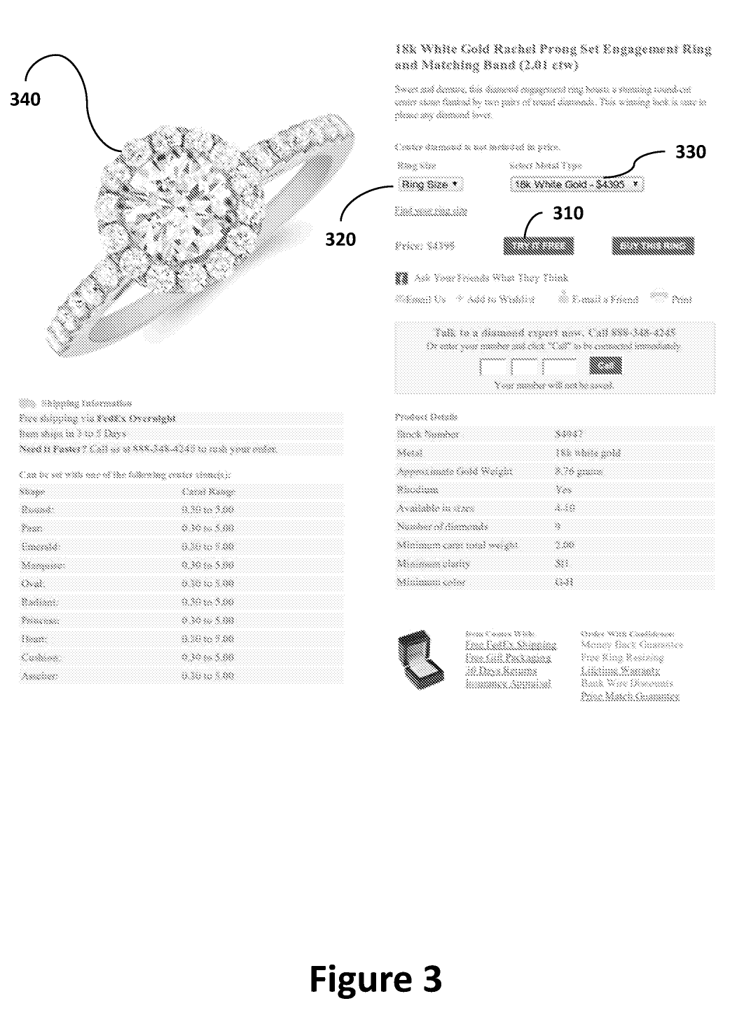

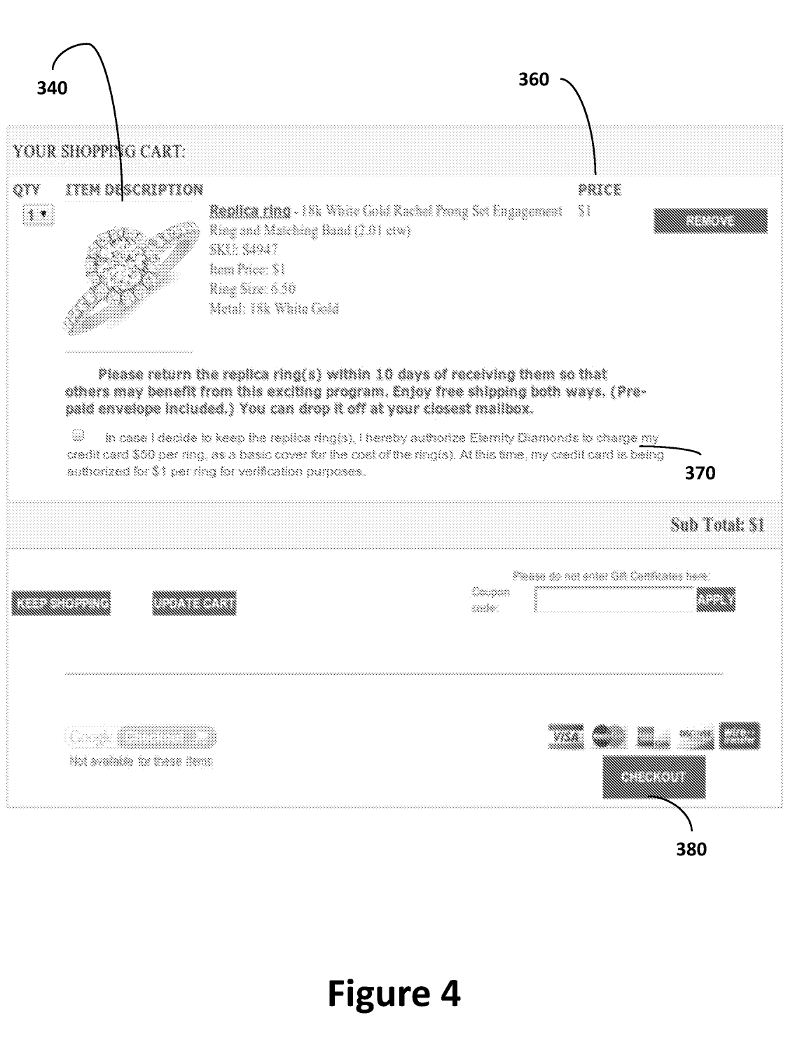

FIG. 1 shows a high level diagram of a method of carrying out embodiments of the disclosed technology. In step 110, a selection of one or a plurality of pieces of jewelry or another product is received from a potential buyer. The potential buyer may select any number of pieces of jewelry, as allowed by the seller, and provide contact information, such as name, phone number, and address, and in some cases, billing information.

In step 120, a functional look-alike version is sent to the customer. A “functional look-alike,” for purposes of this disclosure is defined as an item having generally the same characteristics as the desired product, which works fully or partially (at least 50%) like the real product, and which has a street value of substantially less (wherein “substantially” is defined as at least 50%, 75%, or 90% less) than the actual version. “Generally,” for purposes of this disclosure, is defined as when an average end user of such a product gives the product a cursory look, the product at least appears to be the actual product. For example, in the case of a diamond ring with a gold band, a functional look-alike might be a cubic zirconia gem with a band made out of another metal (such as silver, steel, brass, copper, or the like), but having a color similar to that of the desired product/product selected by the potential buyer. In other embodiments, a metal may be replaced with, for example, a hard plastic or other material.

Upon sending the functional look-alike to a potential buyer of the desired product, one of three paths is offered to him/her, as is shown in FIG. 1. Funds may be reserved, such as on a credit card of the potential buyer, in case the functional look-alike is not returned within a pre-designated time period (such as 10 days), as shown in step 130. A fee may be charged for this service, as shown in step 135. Both steps 130 and 135 may be carried out (not shown in Figure). Or, payment may be received from the customer for the value of the functional look-alike before or at a time of shipping the functional look-alike. That is, the customer may actually purchase the functional look-alike at a market price sale value, wholesale value, or cost. “Before or at the time of shipping” is defined as, at least, sending payment information to the seller of the look-alike/replica when checking out, or via another method, such as over the phone before the seller ships the item.

In step 140, which is carried out regardless of whether step 130 and/or 135 is carried out, a determination is made as to whether the look-alike item was returned within a predetermined amount of time. If it was not returned, for example, within 10 or 30 days, then the potential buyer of the real product becomes a purchaser of the look-alike version. The funds which are reserved, if carried out in step 30, are then transferred to the seller from the potential buyer, who is now a buyer of the look-alike.

In step 140, if the look-alike is returned within the predetermined time period, then step 150 may be carried out, and that is the end of the procedure of carrying out the disclosed method. However, in other embodiments, such as based on an indication from the potential buyer that he wishes to buy the selected piece of jewelry or other item from step 110, the buyer is billed for the selection. Any fee charged may be credited towards this purchase, in embodiments of the disclosed process, and the selected piece of jewelry, plurality of pieces of selected jewelry, or other selected items, are then shipped by mail or courier to the buyer.

In an embodiment of the disclosed process, an online ordering system is utilized, whereby replicas of products to be sampled are placed into a shopping cart. This may be accomplished, for example, by clicking on a “TRY IT FREE” button or other similar button. The sample (look-alike) is then shipped to the buyer. The buyer then has, for example, ten days to try the item, show it to friends and family, and then return it. In some embodiments, a pre-paid return envelope is included, so the buyer incurs no expense at all for sampling.

In an embodiment of the disclosed technology, a ring sizing device (finger circumference measuring device) is included with the look-alike version, enabling the potential buyer to accurately order the desired size of the item to be purchased. Similarly, other such calibration or measuring devices may be provided to aid a potential buyer in making a purchase of the genuine version of the device to be procured.

FIG. 2 shows another method of carrying out aspects of the disclosed technology. In another embodiment of the disclosed technology, a full priced item is exhibited in an online or print catalog in step 210. This may be as part of an e-commerce website, a printed mailing, or the like. It serves as an advertisement for a product, such as a diamond necklace, ring, evening gown or other “expensive” article of clothing, or the like. A person desiring to purchase such a product may be uncomfortable with paying for the product and being subject to restocking and other fees to return the item. So, in step 220, instead of purchasing the product, the customer or potential customer may request to receive a less expensive version of the exhibited product. A fee may be charged for this service, or the price of the less expensive version may be charged. In the case of, for example, a diamond ring, a functional look-alike version made from aluminum and plastic may be worth $5 or $10, whereas the exhibited item may sell for $5,000 or more, by way of example.

In order to ship the less expensive version, which may be 50%, 80%, 90% or even less expensive, in step 230 a shipping address is received from the customer (or potential customer). In step 240, a version of the item which has less than 50% of the materials of the exhibited item is shipped. That is, the customer is sent an item which was not shown in the catalog. This item sent is of less value and is made from different materials, has aesthetic, shape, and functional characteristics of the full-priced exhibited item. For example, a shipped version of the ring may have similar overall contours, a similar color, and a hole for a finger approximately the size of the exhibited/full price item. “Aesthetic” is defined as looking like the real item from afar and having the same general shape, so as to be comparable to the full-priced item. “Functional” is defined as being able to be used for the primary purpose, at least as long as is necessary to try out the object and determine if the full priced version should be bought. Approximate “shape” is defined as being no greater or smaller than a 25% ratio difference for any recognizable attribute (e.g. width or length of a part of the item) in an item over 3 cm long on the version sent, compared to at least one of the full-priced versions of the item. Approximate “size” is defined as being of any typical size for an item which is known in the art to function in the same manner (for rings, different sized rings from size 3 to 12, in some instances).

In examples of the above, rings, for example, which come in different sizes and thicknesses, but are all of the same design are considered to be functional lookalikes. In another example, a functional look-alike of the ring itself may be sent; however, a ring with a halo (a ring of diamonds or other diamonds around a center diamond) may have different versions of a size of the halo in the full priced product, compared to the functional look-alike. The functional look-alike is of the ring and centrally spaced diamond; that is, the major features of the ring, or the overall impression of the ring, remains intact. The functional look-alike/shipped version made of different materials and/or having a much smaller value, shares a shape, size, aesthetic quality, and functional quality with one of the full-priced items (at least so that the overall impression and ability to tryout the item remains the same), made from the materials shown in the catalog offering. In this manner, the object sent will look approximately like the real item. Thus, especially for wearable items such as clothing and jewelry, a person can try out the item by buying or procuring an inexpensive version.

In step 250, the shipped version of the item, that is, the item made of materials that differ from those shown in the catalog and/or having a substantially lesser value, is returned to the seller. This step is optional, depending on the embodiment. In any case, in step 260, it is determined whether the customer desires to purchase the item exhibited in step 210 in the catalog offering. If the customer provides no response or a negative response, the method in step 270 ends. If the customer indicates a desire to purchase the item, by contacting the seller or an associate, and payment is received for the exhibited item in step 280, the exhibited item 290 is sent. This is defined as sending a full-priced version of the item exhibited, made of the materials of the item exhibited. The actual item pictured is usually not sent, as is obvious to one of ordinary skill in the art. When it is stated in this disclosure that the full-price version or originally exhibited version of the item is shipped, it is defined as sending an item which in the ordinary scope of commerce is considered legally and socially acceptable to send a product represented by the exhibited item in the catalog. On the other hand, a functional look-alike or substantially less expensive item is defined as an item which is legally and socially non-acceptable to be sent to a purchaser who thinks he/she is purchasing the item exhibited in a catalog. Thus, the full-price version or originally exhibited version which is sent may vary in size, and in some cases, color, but has a value of the actual exhibited item and/or prices shown in the catalog offering for the variation in size or color shown. The functional look-alike, too, may vary in color and may be a color of any of the full-priced versions, or in the same color family.

FIG. 3 shows a catalog page used to carry out embodiments of the disclosed technology. While the catalog page shown is from an online offering, a print catalog is also contemplated as being within the scope of the disclosed technology. An item offered for sale on this catalog page is shown—in this case, ring 340 and a variation thereof. Likewise, this ring 340 comes in a variety of sizes 320 and types of metal 330. It should be understood that these variations in size and metal are variations of the exhibited ring 340 which are outside of the definition of a “look-alike” version, as used in this specification. Rather, such variations are, for purposes of this disclosure, considered to be the exhibited item. Similarly, for purposes of this disclosure, a ring made from the materials and having the size shown in the ring 340 is considered to be the exhibited item, when, in fact, a different ring possessing these qualities is used in its place, as this is how business is generally conducted. However, a novel feature of the present technology is shipping a look-alike version which is procured from different metals than any of those listed for the exhibited item in metals list 330. The metals list for an item, such as the ring 340. might include, for example, white gold, yellow gold, platinum, and/or silver. The look-alike version is at least 50% or 80% less expensive than the cheapest exhibited variation of the exhibited item and is produced from a different metal than that exhibited or advertised for the product offering. In order to request such a look-alike item, a person may, in this example, choose the “TRY IT FREE” option 310.

FIG. 4 shows an electronic shopping cart screen used to carry out embodiments of the disclosed technology. Again, it should be understood that the items shown on the electronic shopping cart screen may be presented to a customer/buyer in other mediums, such as in a print catalog, via a telephone order, or the like. Again, the full priced version of the item 340 is shown. The price shown 360, in this embodiment, is $1, reflecting a temporary authorization on a credit card, or the cost of buying the replica or look-alike version. The look-alike version is a replica having substantially less value than any variation of the item exhibited. Note also, in this embodiment, notice 370 is displayed (or otherwise exhibited or recited) to the customer, stating roughly, “In case I decide to keep the replica ring(s), I hereby authorize the seller of the ring to charge my credit card $50 per ring, as a basic cover for the cost of the ring(s). At this time, my credit card is being authorized for $1 per ring for verification purposes.” Thus, a person must check the box or agree to potentially be charged in the future.

Referring now to FIGS. 3 and 4 concurrently with FIG. 2, in step 210 a full-priced version of the item is exhibited, which may be ring 340. A request for a less expensive version (a look-alike version or replica) in step 220 may be accomplished by hitting the “TRY IT FREE” button 310 and/or the checkout button 380, combined with the item shown 340 and price listed 360. A shipping address is received 230 (not shown) and a version of the item with less than 50% of the materials of the exhibited item is sent in step 240. Now referring also to FIG. 1, in the case shown in FIGS. 3 and 4, a fee is charged (step 135), in this case, a $1 per look-alike ring. If this ring is not returned within a predetermined time period (step 140), then the customer is billed for the look-alike version (step 160, notice 370). In this embodiment shown in FIG. 4, the credit card is charged $50 based on the customer's pre-authorization thereof. The customer may also decide to buy the exhibited item; payment is received in step 280, and the exhibited item shipped to the buyer in step 290.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

I claim:

1. A method of delivering jewelry by mail comprising the steps of:
exhibiting an image of a jewelry item to a customer;
sending a functional look-alike version of said jewelry item to said customer, wherein said functional look-alike version is of substantially lesser value than said jewelry item;
exhibiting an offer for sale for said jewelry item to said customer and waiting for a response; and
sending said jewelry item to said customer if said response is positive.

2. The method of claim 1, wherein substantially less is 50% lesser value.

3. The method of claim 2, wherein said functional look-alike version is a version of said jewelry item, wherein each metal is replaced with less expensive metal and precious stones are replaced with either plastic or glass replicas.

4. The method of claim 3, wherein billing information is received from said customer before sending said functional look-alike item and said customer is notified that said billing information will be used to charge said customer.

5. The method of claim 4, wherein said charge to said customer for said functional look-alike item is made only if said customer fails to return said functional look-alike item after a predetermined period of time.

6. The method of claim 3, wherein, using said billing information, funds are reserved in the amount of a purchase price of said functional look-alike.

7. The method of claim 3, wherein a separate fee is charged to said customer before sending said functional look-alike.

8. The method of claim 1, wherein customer billing information provided upon return of said functional look-alike is used to charge said customer for said jewelry item.

9. The method of claim 1, wherein said method is carried out simultaneously for a plurality of pieces of jewelry for said customer.

10. The method of claim 2, wherein said functional look-alike comprises the same shape and color of said jewelry item.

11. A method, comprising the steps of:
exhibiting an item for sale in a catalog;
receiving a shipping address and request for a version of said item from a customer;
shipping said version of said item to said customer, said version sharing less than 50% of said materials of said exhibited item and comprising aesthetic, shape, and functional characteristics of said exhibited item;
receiving said version of said item back from said customer;
receiving an indication from said customer regarding a desire to purchase said exhibited item; and
sending said item if said customer desires to purchase said item.

12. The method of claim 11, wherein said item is a plurality of items shipped together and independently purchasable by said customer.

13. The method of claim 11, wherein a fee is assessed to said customer for said shipping of said different version of said item.

14. The method of claim 11, wherein said aesthetic qualities comprise colors in a same color family.

15. The method of claim 14, wherein said functional characteristics comprise an ability to wear an item in the same manner as said item.

16. The method of claim 15, wherein said version of said item shipped has a value of at least 50% less than said item.

17. The method of claim 15, where said value is at least 80% less than said item, and said version of said item is constructed of entirely different materials than that of the exhibited item.

18. The method of claim 16, wherein said item is a piece of jewelry.

19. The method of claim 18, wherein said shape of said shipped version of said item is identical to said item.

20. The method of claim 19, wherein said aesthetic and functional characteristics of said shipped version of said item are additionally identical to said item.

21. The method of claim 1, wherein payment is received from said customer for the value of said functional look-alike before or at a time of shipping said functional lookalike.

22. A method, comprising the steps of:
exhibiting an item for sale in a catalog;
receiving from a customer a shipping address and request to try a lookalike version of said item;
shipping said lookalike version of said item to said customer, said version worth at least 80% less than said exhibited item and comprising aesthetic qualities of said exhibited item including shape, size, and color family;
receiving an indication from said customer regarding a desire to purchase said exhibited item; and
sending said item if said customer desires to purchase said item.

23. The method of claim 22, wherein said lookalike version of said item is received back from said customer before said step of sending.
